(19) United States
(12) Patent Application Publication
(10) Pub. No.: US 2009/0104320 A1
(43) Pub. Date: Apr. 23, 2009

(54) Stabilization of Milk-Based Products

(75) Inventors: Kimberley H. Gray, Loveland, OH (US); Michelle D. Hursong, Latonia, KY (US); Victoria de la Huerga, Union, KY (US); Jeffrey W. Foss, Erlanger, KY (US)

Correspondence Address: FROST BROWN TODD, LLC, 2200 PNC CENTER, 201 E. FIFTH STREET, CINCINNATI, OH, 45202, US

(73) Assignee: WILD FLAVORS INC., Erlanger, KY (US)

(21) Appl. No.: 12/274,572

(22) Filed: Nov. 20, 2008

Related U.S. Application Data
(63) Continuation of application No. 11/011,642, filed on Dec. 14, 2004, now abandoned.
(60) Provisional application No. 60/529,814, filed on Dec. 16, 2003.

(51) Int. Cl. A23C 9/146

(52) U.S. Cl. 426/271

(57) ABSTRACT

Dairy-derived food products, particularly beverages, such as milk/juice blends, yogurt-based drinks, fermented milk beverages, and soft drinks, are disclosed. These compositions contain a stabilizing mixture comprising metal (in the form of ions, salts or oxides) such as zinc or magnesium, either alone or together with an adjunct component such as ascorbic acid. These beverage products do not form off-flavors when they are exposed to sunlight or fluorescent light. This provides for more efficient and inexpensive manufacture of the products and eliminates the need for expensive opaque packing materials.

### CROSS REFERENCE TO RELATED APPLICATION

This application is a continuation of application Ser. No. 11/011,642, filed Dec. 14, 2004 and, further, is based upon and claims priority from U.S. Provisional Patent Application No. 60/529,814, filed Dec. 16, 2003, and U.S. Provisional Patent Application No. 60/554,045, filed Mar. 17, 2004, both of which are incorporated by reference herein.

### BACKGROUND OF THE INVENTION

Milk-based products are susceptible to off-flavor formation when they are exposed to ultraviolet or fluorescent light. The off-flavor formation can result from one of two mechanisms: (1) lipid oxidation, or (2) riboflavin-catalyzed degradation of milk amino acids (i.e., photo-oxidation of methionine to methional). Current efforts to address this issue include packaging milk products in opaque containers (to minimize exposure to light) or the inclusion of ascorbic acid in milk products (to minimize off-flavor formation). The packaging approach results in increased costs for the milk products, while the ascorbic acid approach is not a complete solution and can, itself, result in off-flavors in the milk products. The present invention provides a cost-effective way to prevent or minimize the formation of off-flavors in milk products.

The presence of off-flavors in milk products, from a variety of sources including light-induced off-flavor formation, is a well-known problem in the art and a variety of approaches have been proposed to address it.

Japanese Published Patent Application 2000228952, Hiroshi et al., published Aug. 22, 2000, describes the addition of vitamin E (tocopherol), at from 5 to 5000 ppm, to a milk-containing beverage to prevent the generation of off-flavors.

U.S. Published Patent Application 2003/0129403, Beaverson et al., published Jul. 10, 2003, describes odor-absorbent packaging which is made from a resin and includes within that resin cyclodextrin and nanosized zinc particles. The packaging is specifically taught to absorb light-induced off-flavors in milk products. The approach taken by this reference is to be contrasted with that of the present development in that the described packaging does not prevent the formation of the odors as does the present development, rather it ties up the odors after they are formed. The application teaches that it is preferred that the metal particles contained in the resin be substantially free of their oxide compounds. PCT Publication WO 93/10174 is cited as describing a thermoplastic film which contains aluminum, magnesium, manganese or zinc powder.

U.S. Pat. No. 5,888,563, Mehansho et al., granted Mar. 30, 1999, describes a milk- or soy-based beverage which is formulated to minimize off-flavors caused by the inclusion of mineral supplements, such as iron. The beverage utilizes an emulsifier capable of forming a bilayer structure to provide the desired result. Iron fumarate and zinc fumarate are among the supplements included in the beverages. Example III describes a milk-based beverage which contains iron, zinc and ascorbic acid; the levels and proportions used of these materials are not disclosed in the example.

U.S. Published Patent Application 2003/0194468, Konkoly et al., published Oct. 16, 2003, describes a method for producing a nutritionally fortified dairy beverage. The application teaches the inclusion of vitamins and minerals at dietary supplement levels in the beverage. The beverage is a yogurt-based cultured dairy beverage.

U.S. Published Patent Application 2002/0155194, Mehansho et al., published Oct. 24, 2002, describes stabilizing dairy compositions which utilize arabinogalactan to provide fiber and to stabilize the composition. The application teaches that the inclusion of some minerals (for example, iron) can lead to the formation of off-flavors in the compositions. It is taught that the compositions may be fortified with vitamins and minerals at supplementation levels.

U.S. Pat. No. 5,529,926, Maat, granted Jun. 25, 1996, describes a DNA sequence for a polypeptide having sulfhydryl oxidase (SOX) activity. It is taught that this polypeptide can be used to remove the burnt flavors during the ultrahigh temperature sterilization of milk.

### SUMMARY OF THE INVENTION

The present invention relates to dairy-derived food products (particularly beverages) comprising:

(a) from about 0.01% to about 20% dairy protein;

(b) a stabilizing mixture comprising:
i. from about 0.000001% to about 0.2% (preferably from about 0.000001% to about 0.1%) of a metal (in the form of ions, metal compounds, oxides, complexes, chelates, or nonionic forms) selected from zinc, magnesium, calcium, chromium, copper, iron, selenium, manganese, and combinations thereof; and
ii. from about 0.01% to about 2.5% (preferably from about 0.01% to about 1.5%) of an adjunct component selected from ascorbic acid, erythorbic acid, ascorbates, erythorbates, sugar alcohols, and combinations thereof.

Preferred metals (present in the form of ions or compounds) include zinc, magnesium and manganese, and preferred adjunct components include ascorbic acid and inositol.

The present invention also relates to dairy-derived beverage products selected from milk, flavored milk, milk/juice blends, cultured and noncultured dairy-based drinks, acidified milk beverages, and soft drinks, comprising:

(a) from about 0.01% to about 20% dairy protein; and

(b) from about 0.000001% to about 0.2% (preferably from about 0.000001% to about 0.1%) of a metal (present in the form of ions, metal compounds, oxides, complexes, chelates, or nonionic forms) selected from zinc, magnesium, calcium, chromium, copper, iron, selenium, manganese, and combinations thereof. Preferred metals include zinc, magnesium and manganese.

The present invention also relates to dairy-derived non-beverage products, such as pudding or custards. It also relates to cultured dairy-derived products, such as cup yogurt, salad dressing (buttermilk or RANCH®-type dressing), sour cream, dips and cottage cheese.

All percentages and ratios noted herein are “by weight” unless otherwise specified. As used in the claims, the percentages for the “metals” component are based on the weight of the metals themselves, not the entire compound used to introduce the metals into the compositions.

### DETAILED DESCRIPTION OF THE INVENTION

The present invention relates to dairy-derived food products, particularly (but not limited to) beverages, which minimize the formation of off-flavors when subjected to sunlight or fluorescent light. These compositions include several required components including dairy protein, and a stabilizing component which comprises a metal or a mixture of metals (present in the form of ions or metal compounds, complexes, oxides, chelates, or nonionic forms) with an adjunct component, such as ascorbic acid. These components, as well as optional additional components which may be included in the compositions of the present invention, are described below.

The present invention relates to dairy-derived food products which contain from about 0.01% to about 20%, preferably from about 0.01% to about 10%, more preferably from about 0.05% to about 4%, of dairy protein. Preferred products encompassed within the present invention are dairy-derived beverages such as milk, flavored milk, milk/juice blends, cultured and noncultured dairy-based drinks, acidified milk beverages, carbonated and noncarbonated beverages, soft drinks, and yogurt-based beverages (such as smoothies and lassi). Non-beverage cultured dairy-derived products, such as yogurt, sour cream, salad dressings (buttermilk or RANCH®-type), dips and cottage cheese, and non-beverage non-cultured dairy-derived products, such as puddings or custards, are also included in the present invention.

The dairy protein which may be utilized in the present invention is commonly known in the art. Dairy protein may include, for example, all forms of milk (e.g., mammalian). Milk includes, but is not limited to, whole milk, skim milk, condensed milk, evaporated milk, reduced fat milk, low fat milk, nonfat milk, and milk solids (which may be fat or nonfat). Some compositions encompassed within the present invention are substantially free of yogurt (i.e., cultured or fermented milk). By “substantially free of yogurt,” it is meant that the composition comprises less than about 1 million bacteria per gram of the composition, preferably less than about 500,000 bacteria per gram of the composition, even more preferably less than about 200,000 bacteria per gram of the composition, and most preferably less than about 100,000 bacteria per gram of the composition. Typical yogurts contain about 1 billion bacteria per gram of the yogurt. See James M. Jay, Modern Food Microbiology, 4^{th} edition, Chapman & Hall, page 379 (1992). As used herein, the term “bacteria” includes both live and dead bacteria.

The compositions of the present invention typically include from about 0.01% to about 20%, more preferably from about 0.01% to about 10%, even more preferably from about 0.05% to about 5%, and most preferably from about 0.05% to about 4% of the dairy protein, wherein the amounts are expressed in terms of milk solids, by weight of the composition.

The metals which may be used to stabilize the compositions and prevent the formation of off-flavors include zinc, magnesium, calcium, chromium, copper, iron, selenium, manganese, and mixtures thereof. Preferred metals include zinc, magnesium, calcium, copper, iron, manganese, and mixtures thereof. These metals are included in the compositions in their ionic form or as compounds, such as oxides; they may be introduced into the compositions in their oxide form or in the form of various salts, such as gluconates, ascorbates, citrates or lactates. For example, as used herein, “zinc” is intended to include any compound containing zinc, including a salt, complex, or other form of zinc. Acceptable forms of zinc are well known in the art. The zinc which can be used in the present invention can be in any commonly used forms such as, e.g., zinc lactate, zinc sulfate, zinc chloride, zinc acetate, zinc gluconate, zinc ascorbate, zinc citrate, zinc aspartate, zinc picolinate, amino acid chelated zinc, and zinc oxide. Zinc oxide and zinc gluconate are preferred ways of introducing zinc into the compositions of the present invention. The other metal ions listed above may be introduced into the compositions of the present invention in their salt or oxide or complex forms as described above for zinc. The metals may be used alone or in mixtures with each other.

When zinc oxide is used as the source for zinc, the zinc oxide is included in the compositions at levels of from about 0.0002% to about 0.5%, preferably from about 0.0004% to about 0.05% (based on the amount of the oxide included). Magnesium oxide, magnesium phosphate tribasic pentahydrate, magnesium carbonate, magnesium gluconate, magnesium ascorbate, and magnesium malate are included in the compositions, when used, at levels of from about 0.0005% to about 0.2%, and is preferably used at levels from about 0.0007% to about 0.05%. Calcium salts, such as calcium oxide, calcium lactate, calcium hydroxide, or calcium chloride, can be used in the compositions at levels of from about 0.05% to about 0.75%, preferably from about 0.0075% to about 0.5%. Zinc, magnesium and manganese are preferred metals for use in the present invention, with zinc and manganese being particularly preferred.

The adjunct stabilization components used in the present invention include ascorbic acid, sugar alcohols, erythorbic acid, ascorbates, erythorbates, and mixtures thereof. Thus, for example, sodium erythorbate or ascorbyl palmitate may be used in place of erythorbic acid or ascorbic acid. Sugar alcohols (polyols) are well known in the art and are derived from sugar molecules. They include, for example, sorbitol, mannitol, xylitol, lactitol, maltitol, isomalt, hydrogenated starch hydrolysates, erythritol, inulin, galactitol, inositol, ribitol, dithioerythritol, dithiothreitol, and glycerol. Mannitol, inositol, xylitol, and erythritol are preferred sugar alcohols for use in the present invention. A preferred adjunct material is ascorbic acid. When used, ascorbic or erythorbic acid or their acid salts are present in the compositions at from about 0.01% to about 0.3%, preferably from about 0.02% to about 0.15%. Mixtures of adjunct materials may be used in the compositions of the present invention. Preferred are mixtures of metals (in the form of ions, salts, oxides, complexes, chelates, or nonionic forms) with adjunct materials. Particularly preferred are mixtures of magnesium, manganese and/or zinc (in the form of ions, salts, oxides, complexes, chelates, or nonionic forms) together with ascorbic acid. In such mixtures, the zinc, manganese and/or magnesium are each typically used at levels of from about 0.0004% to about 0.03%; and the ascorbic acid is used at levels of from about 0.02% to about 0.15%.

Exemplary compositions of the present invention include a metal selected from: from about 0.0013% to about 0.34% magnesium, from about 0.000013% to about 0.0034% manganese, from about 0.000025% to about 0.0031% iron (ferrous or ferric), from about 0.0000048% to about 0.00048% copper, from about 0.0065% to about 0.65% calcium, from about 0.00037% to about 0.037% zinc, and combinations thereof; and an adjunct compound selected from 0.01% to about 1% sugar alcohol, from about 0.001% to about 0.2% ascorbic acid, and combinations thereof.

Sources of magnesium include, for example, magnesium oxide, magnesium carbonate, magnesium citrate, magnesium gluconate, magnesium ascorbate, magnesium malate, magnesium lactate, magnesium succinate, magnesium hydroxide, magnesium chloride, magnesium stearate, magnesium sulfate, magnesium phosphate, and combinations thereof. Preferred materials include magnesium oxide, magnesium carbonate, magnesium ascorbate, magnesium malate, magnesium phosphate, and combinations thereof. Of course, other sources may be used for magnesium, and for the other metals described below.

Sources of manganese include, for example, manganese gluconate, manganese ascorbate, manganese lactate, manganese sulfate, manganese carbonate, manganese oxide, manganese chloride, manganese citrate, and combinations thereof. Preferred materials include manganese gluconate, manganese sulfate, manganese citrate, and combinations thereof.

Sources of sugar alcohol include, for example, mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof. Inositol, xylitol, mannitol and/or erythritol are preferred.

Sources of iron for use in the present invention include, for example, ferric ammonium citrate, ferric chloride, ferric phosphate, ferric sulfate, ferrous ascorbate, ferrous carbonate, ferrous sulfate, ferrous gluconate, ferrous lactate, ferrous fumarate, and combinations thereof. Preferred materials include ferric ammonium citrate, ferrous gluconate and/or ferrous sulfate.

Sources of copper for use in the present invention include, for example, copper citrate, copper acetate, copper sulfate, copper gluconate, and combinations thereof. Copper gluconate is preferred.

Sources of calcium for use in the present invention include, for example, calcium lactate, calcium citrate, calcium sulfate, calcium hydroxide, calcium carbonate, calcium acetate, calcium gluconate, calcium oxide, calcium proprionate, calcium stearate, calcium chloride, and combinations thereof. Calcium lactate and/or calcium citrate are preferred.

Sources of zinc for use in the present invention include, for example, zinc oxide, zinc lactate, zinc citrate, zinc picolinate, zinc sulfate, zinc chloride, zinc stearate, zinc gluconate, and combinations thereof. Zinc oxide and/or zinc gluconate are preferred.

When certain stabilizing components are included in the compositions of the present invention, particularly when they are included at high levels, flavor-masking components can be added to mask any off-flavors which accompany the use of those stabilizing adjunct materials. For example, the use of very high levels of ascorbic acid or iron can result in off-flavors to the composition. Flavor-masking ingredients are well known in the art and include, for example, vanilla extracts, licorice extracts, glycyrrhizin, thaumatin, and mixtures of those materials. Such flavor-masking components are, for example, described in Modifying Bitterness: Mechanism, Ingredients and Applications, edited by G. Roy, Technomic Publishing Company, Inc., 1997, Lancaster, Pa., incorporated herein by reference.

The compositions of the present invention may also include other components conventionally known and used in beverage products. Examples of such materials include, for example, flavoring agents, coloring agents, preservatives, emulsifiers, carbonation components, and other safe and compatible components.

One or more flavoring agents may be used in the compositions of the present invention in order to enhance their palatability. Any natural or synthetic flavoring agent can be used in the present invention, as long as it is safe for consumption and compatible with the other components in the composition. For example, one or more botanical and/or fruit flavors may be utilized. Such flavors may be synthetic or natural flavors. Particularly preferred fruit flavors are exotic and lactonic flavors such as, for example, passion fruit flavors, mango flavors, pineapple flavors, cupuacu flavors, guava flavors, cocoa flavors, papaya flavors, peach flavors, and apricot flavors. Besides these flavors, a variety of other fruit flavors can be utilized, such as, for example, apple flavors, citrus flavors, grape flavors, raspberry flavors, cranberry flavors, cherry flavors, grapefruit flavors, and the like. These fruit flavors can be derived from natural sources such as fruit juices and flavor oils, or may alternatively be synthetically prepared.

Preferred botanical flavors include, for example, tea (for example, black, white, red, oolong and green tea), aloe vera, guarana, ginseng, gingko, hawthorn, hibiscus, rosehips, chamomile, peppermint, fennel, ginger, licorice, lotus seed, schizandra, saw palmetto, sarsaparilla, safflower, St. John's wort, curcuma, cardamom, nutmeg, cassia bark, buchu, cinnamon, jasmine, haw, chrysanthemum, water chestnut, sugar cane, lychee, bamboo shoots, vanilla, coffee, and the like. Preferred among these are tea, guarana, ginseng, gingko, and coffee. The flavor agents can also comprise a blend of various flavors. “Ice cream” flavors, such as vanilla, chocolate, strawberry, mocha and mint, to name a few, may also be used.

Small amounts of one or more coloring agents may be utilized in the compositions of the present invention. FD&C dyes (e.g., yellow no. 5, blue no. 2, red no. 40) and/or FD&C lakes are preferably used. Additionally, a mixture of FD&C dyes or FD&C lake dye in combination with other conventional food and food colorants may be used. Riboflavin and beta carotene may also be used. Additionally, other natural coloring agents may be used including, for example, fruit, vegetable, and/or plant extracts such as grape, black currant, aronia, carrot, beet root, red cabbage, hibiscus, anthocyanins, betalins, turmeric, curcumin, annatto, carotenoids, cochineal, carminic acid, and carmine. The amount of coloring agent used will vary, depending on the identity of the agents used and the intensity of color desired in the finished product. These materials are used at their conventional art-established levels.

Preservatives may or may not be needed for use in the present compositions. Techniques such as aseptic, hot fill, tunnel pasteurization, ultrahigh temperature (UHT) retort, and/or clean fill processing may be utilized to avoid the need for preservatives. One or more preservatives may, however, optionally be added to the present compositions at their art-established levels. Preferred preservatives include, for example, sorbate, benzoate, and polyphosphate preservatives (for example, sodium hexametapolyphosphate).

Carbon dioxide can be introduced into the beverages of the present invention to achieve carbonation. The carbonated beverage can be placed into a container, such as a bottle or can, and then sealed. Any conventional carbonation methodology may be utilized to make carbonated beverage compositions of the present invention. The amount of carbon dioxide introduced into the beverage will depend upon the particular flavor system utilized and the amount of carbonation desired.

The compositions of the present invention typically have a pH between about 2.5 and about 8.0. The pH may be adjusted by manipulation of the component levels (e.g., lactic acid or phosphates).

The present compositions can be made by conventional processes known in the art. The mixture of metals (in the form of ions/salts, oxides, complexes, chelates, or nonionic forms) and adjunct stabilization components can be made from a blend of the powder form of these components. Preferably, the powders will be of similar particle size to facilitate a homogeneous blend. This blend can, in turn, be mixed with powdered flavor and/or other powders present in the product to aid in the processing of the finished product. The mixture of metal components (in the form of ions/salts, oxides, complexes, chelates or nonionic forms) and adjunct stabilization components can be added directly during processing to the finished product as individual components.

The beverage product itself may be manufactured, for example, as follows: Disperse and dissolve the powdered proteins in a portion of the water in the mixing vessel. In a separate container, a portion of the remaining water is heated to 140-180° F. The stabilizer blend is dissolved and dispersed in the hot water; when completely dissolved, the solution is added to the mixing vessel. The dairy base is added to the mixing vessel and is mixed well. Any remaining water is added to the mixing vessel and is mixed well. Add any desired sweeteners, juices, acids, color and flavor. The product may be homogenized if desired. The entire contents of the mixing vessel is pasteurized at 190-195° F.

The following are nonlimiting examples of compositions of the present invention. The compositions are prepared utilizing conventional methods. The following examples are provided to illustrate the invention and are not intended to limit the scope thereof in any manner.

### EXAMPLES

Using the manufacturing procedure described above, the following compositions are made and tested. After the pasteurization step, the finished beverage is kept in one of three storage conditions for evaluation: control (refrigerated, no light exposure); refrigerated (approximately 45° F.) fluorescent light box (minimum five days before evaluation); and light box (ten hours, sunlight tester, Atlas Suntest, Model XLS+, manufactured by Atlas Material Testing Technology, LLC, Chicago, Ill.).

Coded samples are evaluated blindly by a trained panel of at least five persons in a modified ranking. Six to eight samples are included in each tasting session. A coded, nonstabilized “control” sample is also included in each session. Samples kept in the dark are tasted and compared to light-exposed samples. The test can continue for various lengths of time (e.g., 10 hours, seven days, two weeks, one month, two months). The tasters rank the samples “1” to “8” (for eight samples) or “1” to “6” (for six samples), with “1” being the best and “8” (or “6”) being the worst. All rankings are added together to give a combined ranking score for each sample. Lower rankings than the control ranking are considered improvements.

Control

| Ingredient | % (by weight) |
|---|---|
| HFCS 55¹ | 10.1 |
| Dairy Base² | 9.2 |
| Ascorbic Acid | 0.035 |
| Lactic Acid | 0.15 |
| Genu Pectin VIS ™³ | 0.19 |
| Genu Pectin YM-100H ™⁴ | 0.29 |
| Water | Balance to 100 |

¹HFCS 55 is a high fructose corn syrup having a fructose content of 55.
²A milk-derived product which contains about 2% dairy protein (thereby providing the entire composition with about 0.2% of dairy protein).
³A pectin material commercially available from C.P. Kelco, Inc., Wilmington, Del. (now owned by J. M. Huber).
⁴A pectin material commercially available from C.P. Kelco, Inc., Wilmington, Del. (now owned by J. M. Huber).

The composition is pasteurized and tested as described in the following examples.

### Example 1

| Ingredient | % |
|---|---|
| HFCS 55¹ | 10.1 |
| Dairy Base² | 9.2 |
| Ascorbic Acid | 0.035 |
| Lactic Acid | 0.15 |
| Genu Pectin VIS ™³ | 0.19 |
| Genu Pectin YM-100H ™⁴ | 0.29 |
| MgO | 0.00067 |
| Water | Balance to 100 |

The composition is pasteurized and exposed to 10 hours of light in a sunlight tester. The Example 1 sample is tasted and compared to the control sample kept in the dark. All tasters rate the Example 1 sample as better than the control sample (no stabilizer).

### Example 2

| Ingredient | % |
|---|---|
| HFCS 55¹ | 10.1 |
| Dairy Base² | 9.2 |
| Ascorbic Acid | 0.035 |
| Lactic Acid | 0.15 |
| Genu Pectin VIS ™³ | 0.19 |
| Genu Pectin YM-100H ™⁴ | 0.29 |
| ZnO | 0.00039 |
| Water | Balance to 100 |

The composition is pasteurized and exposed to 10 hours of light in a sunlight tester. The Example 2 sample is taste compared to a control sample kept in the dark. Tasters rate the Example 2 sample as better than the control sample (no stabilizer).

### Example 3

| Ingredient | % |
|---|---|
| HFCS 55¹ | 10.1 |
| Dairy Base² | 9.2 |
| Ascorbic Acid | 0.15 |
| Lactic Acid | 0.15 |
| Genu Pectin VIS ™³ | 0.19 |
| Genu Pectin YM-100H ™⁴ | 0.29 |
| Mannitol | 0.48 |
| Calcium lactate pentahydrate | 0.46 |
| ZnO | 0.0046 |
| Water | Balance to 100 |

The composition is pasteurized and exposed to 10 hours of light in a sunlight tester. The Example 3 sample is taste compared to a control sample kept in the dark. All tasters rate the Example 3 sample as better than the control sample (no stabilizer).

Additional examples of the present invention have the following formulations.

### Example 4

| Ingredient | % |
|---|---|
| HFCS 55¹ | 10.8 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate, Green | 0.002 |
| Manganese Ascorbate | 0.0012 |
| Inositol | 0.10 |
| Copper Gluconate | 0.00034 |
| Zinc Gluconate | 0.0276 |
| Water | Balance to 100 |

### Example 5

| Ingredient | % |
|---|---|
| HFCS 55¹ | 10.8 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate, Green | 0.002 |
| Manganese Ascorbate | 0.0012 |
| Magnesium Malate Trihydrate | 0.1456 |
| Copper Gluconate | 0.00034 |
| Zinc Gluconate | 0.0276 |
| Water | Balance to 100 |

### Example 6

| Ingredient | % |
|---|---|
| HFCS 55¹ | 10.8 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate, Green | 0.002 |
| Manganese Ascorbate | 0.0012 |
| Magnesium Malate Trihydrate | 0.1456 |
| Inositol | 0.50 |
| Copper Gluconate | 0.00034 |
| Zinc Gluconate | 0.0276 |
| Water | Balance to 100 |

### Example 7

| Ingredient | % |
|---|---|
| HFCS 55¹ | 10.8 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Zinc Citrate | 0.01214 |
| Copper Gluconate | 0.00034 |
| Water | Balance to 100 |

### Examples of Dairy-Based Beverages

I. Unflavored Dairy-Based Beverages—The following examples are all made using conventional techniques, and are tested in the Atlas SunTest XLS+ for 10 hours (all examples test better than control) and in a dairy case set up (refrigerated) for two months (all examples test better than control).

Control

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Water | Balance to 100 |

¹HFCS 55 is a high fructose corn syrup having a fructose content of 55.
²A milk-derived product which provides the final composition with 0.2% dairy protein (the dairy base contains about 2% dairy protein).
³A pectin material commercially available from C.P. Kelco, Inc., Wilmington, Del. (now owned by J. M. Huber).
⁴A pectin material commercially available from C.P. Kelco, Inc., Wilmington, Del. (now owned by J. M. Huber).

### Example 8

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 9

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferrous Gluconate | 0.002012 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 10

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Citrate Tribasic Hydrate | 0.000657 |
| Calcium Citrate Tetrahydrate | 0.313 |
| Copper Gluconate | 0.000343 |
| Zinc Gluconate | 0.0276 |
| Water | Balance to 100 |

### Example 11

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Inositol | 0.10 |
| Water | Balance to 100 |

### Example 12

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferrous Lactate | 0.001312 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 13

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Sulfate Monohydrate | 0.0004136 |
| Calcium Citrate Tetrahydrate | 0.313 |
| Copper Gluconate | 0.000343 |
| Zinc Gluconate | 0.0276 |
| Water | Balance to 100 |

### Example 14

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Malate Trihydrate | 0.1456 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 15

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Lactate Pentahydrate | 0.473 |
| Copper Gluconate | 0.000343 |
| Zinc Gluconate | 0.0276 |
| Water | Balance to 100 |

### Example 16

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Xylitol | 0.10 |
| Water | Balance to 100 |

### Example 17

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Oxide | 0.0048 |
| Water | Balance to 100 |

### Example 18

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Mannitol | 0.10 |
| Water | Balance to 100 |

### Example 19

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Masking Flavor | 0.000033 |
| Ferric Ammonium Citrate | 0.002034 |
| Magnesium Oxide | 0.021 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

II. Flavored Dairy-Based Beverages—All following examples are made using conventional techniques and are tested in the Atlas SunTest XLS+ for 10 hours (all examples test better than control) and in a dairy case set up (refrigerated) for two months (all examples test better than control). pH adjustments are made with lactic acid to around pH=3.7 for stability purposes.

Control

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Water | Balance to 100 |

¹HFCS 55 is a high fructose corn syrup having a fructose content of 55.
²A milk-derived product which provides the final composition with 0.2% dairy protein (the dairy base contains about 2% dairy protein).
³A pectin material commercially available from C.P. Kelco, Inc., Wilmington, Del. (now owned by J. M. Huber).
⁴A pectin material commercially available from C.P. Kelco, Inc., Wilmington, Del. (now owned by J. M. Huber).

### Example 20

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 21

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Inositol | 0.10 |
| Water | Balance to 100 |

### Example 22

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Malate Trihydrate | 0.1456 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 23

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Citrate Tribasic Hydrate | 0.000657 |
| Calcium Citrate Tetrahydrate | 0.313 |
| Copper Gluconate | 0.000343 |
| Zinc Gluconate | 0.0276 |
| Water | Balance to 100 |

### Example 24

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferrous Lactate | 0.001312 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 25

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferrous Gluconate | 0.002012 |
| Magnesium Phosphate Tribasic Pentahydrate | 0.0824 |
| Manganese Gluconate Dihydrate | 0.00147 |
| Calcium Citrate Tetrahydrate | 0.313 |
| Copper Gluconate | 0.000343 |
| Zinc Gluconate | 0.0276 |
| Water | Balance to 100 |

### Example 26

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Sulfate Monohydrate | 0.0004136 |
| Calcium Citrate Tetrahydrate | 0.313 |
| Copper Gluconate | 0.000343 |
| Zinc Gluconate | 0.0276 |
| Water | Balance to 100 |

III. Flavored, No Calcium Dairy-Based Beverages—All following examples are prepared using conventional techniques and are tested in the Atlas SunTest XLS+ for 10 hours (all examples test better than control) and in a dairy case set up (refrigerated) for two months (all examples test better than control). pH adjustments are made with lactic acid to around pH=3.7 for stability purposes.

Control

| Ingredient | % |
|---|---|
| HFCS 55¹ | 10.5 |
| Dairy Base² | 8.0 |
| Ascorbic Acid | 0.036 |
| Lactic Acid | 0.15 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Water | Balance to 100 |

¹HFCS 55 is a high fructose corn syrup having a fructose content of 55.
²A milk-derived product which provides the final composition with 0.2% dairy protein (the dairy base contains about 2% dairy protein).
³A pectin material commercially available from C.P. Kelco, Inc., Wilmington, Del. (now owned by J. M. Huber).
⁴A pectin material commercially available from C.P. Kelco, Inc., Wilmington, Del. (now owned by J. M. Huber).

### Example 27

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Copper Gluconate | 0.000343 |
| Zinc Gluconate | 0.0276 |
| Water | Balance to 100 |

### Example 28

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Gluconate Dihydrate | 0.00147 |
| Copper Gluconate | 0.000343 |
| Zinc Gluconate | 0.0276 |
| Inositol | 0.10 |
| Water | Balance to 100 |

### Example 29

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Malate Trihydrate | 0.1456 |
| Manganese Gluconate Dihydrate | 0.00147 |
| Copper Gluconate | 0.000343 |
| Zinc Gluconate | 0.0276 |
| Water | Balance to 100 |

### Example 30

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Citrate Tribasic Hydrate | 0.000657 |
| Copper Gluconate | 0.000343 |
| Zinc Gluconate | 0.0276 |
| Water | Balance to 100 |

### Example 31

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferrous Lactate | 0.001312 |
| Magnesium Phosphate Tribasic Pentahydrate | 0.0824 |
| Manganese Gluconate Dihydrate | 0.00147 |
| Copper Gluconate | 0.000343 |
| Zinc Gluconate | 0.0276 |
| Water | Balance to 100 |

### Example 32

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferrous Gluconate | 0.002012 |
| Magnesium Phosphate Tribasic Pentahydrate | 0.0824 |
| Manganese Gluconate Dihydrate | 0.00147 |
| Copper Gluconate | 0.000343 |
| Zinc Gluconate | 0.0276 |
| Water | Balance to 100 |

### Example 33

| Ingredient | % |
|---|---|
| HFCS 55¹ | 10.5 |
| Dairy Base² | 8.0 |
| Ascorbic Acid | 0.036 |
| Lactic Acid | 0.26 |
| Genu Pectin VIS³ | 0.20 |
| Genu Pectin YM-100H⁴ | 0.30 |
| Strawberry Flavor | 0.15 |
| Red Color | 0.022 |
| Strawberry Juice (65 Brix) | 0.6 |
| White Grape Juice (68 Brix) | 3.85 |
| Masking Flavor | 0.000033 |
| Ferric Ammonium Citrate | 0.002034 |
| Magnesium Phosphate Tribasic Pentahydrate | 0.0824 |
| Manganese Sulfate Monohydrate | 0.0004136 |
| Copper Gluconate | 0.000343 |
| Zinc Gluconate | 0.0276 |
| Water | Balance to 100 |

### Examples of Milk-Based Beverages

IV. Unflavored 1% Fluid Milk—All following examples are made using conventional techniques and are tested in a dairy case set up (refrigerated) for six days (all examples test better than control).

Control

| Ingredient | % |
|---|---|
| 1% Milk | 100 |

### Example 34

| Ingredient | % |
|---|---|
| 1% Milk | 99.629 |
| Magnesium Ascorbate | 0.268 |
| Manganese Gluconate Dihydrate | 0.00294 |
| Erythritol | 0.1 |

### Example 35

| Ingredient | % |
|---|---|
| 1% Milk | 99.827 |
| Ascorbic Acid | 0.02 |
| Ferrous Gluconate | 0.002012 |
| Magnesium Carbonate | 0.0504 |
| Manganese Sulfate Monohydrate | 0.0008272 |
| Inositol | 0.1 |

### Example 36

| Ingredient | % |
|---|---|
| 1% Milk | 99.825 |
| Ascorbic Acid | 0.02 |
| Ferrous Gluconate | 0.002012 |
| Magnesium Carbonate | 0.0504 |
| Manganese Gluconate Dihydrate | 0.00294 |
| Inositol | 0.1 |

### Example 37

| Ingredient | % |
|---|---|
| 1% Milk | 99.609 |
| Ascorbic Acid | 0.02 |
| Ferrous Gluconate | 0.002012 |
| Magnesium Ascorbate | 0.268 |
| Manganese Citrate | 0.001314 |
| Inositol | 0.1 |

### Example 38

| Ingredient | % |
|---|---|
| 1% Milk | 99.810 |
| Ascorbic Acid | 0.02 |
| Ferrous Gluconate | 0.002012 |
| Magnesium Phosphate Tribasic Pentahydrate | 0.1648 |
| Manganese Gluconate Dihydrate | 0.00294 |

### Example 39

| Ingredient | % |
|---|---|
| 1% Milk | 99.710 |
| Ascorbic Acid | 0.02 |
| Ferrous Gluconate | 0.002012 |
| Magnesium Phosphate Tribasic Pentahydrate | 0.1648 |
| Manganese Gluconate Dihydrate | 0.00294 |
| Inositol | 0.1 |

### Example 40

| Ingredient | % |
|---|---|
| 1% Milk | 99.856 |
| Ascorbic Acid | 0.02 |
| Ferrous Gluconate | 0.002012 |
| Magnesium Oxide | 0.021 |
| Manganese Sulfate Monohydrate | 0.0008272 |
| Inositol | 0.1 |

### Example 41

| Ingredient | % |
|---|---|
| 1% Milk | 99.828 |
| Ascorbic Acid | 0.02 |
| Ferrous Gluconate | 0.002012 |
| Magnesium Carbonate | 0.0504 |
| Inositol | 0.1 |

### Example 42

| Ingredient | % |
|---|---|
| 1% Milk | 99.712 |
| Ascorbic Acid | 0.02 |
| Ferrous Gluconate | 0.002012 |
| Magnesium Phosphate Tribasic Pentahydrate | 0.1648 |
| Manganese Sulfate Monohydrate | 0.0008272 |
| Inositol | 0.1 |

### Example 43

| Ingredient | % |
|---|---|
| 1% Milk | 99.630 |
| Ferrous Gluconate | 0.002012 |
| Magnesium Ascorbate | 0.268 |
| Inositol | 0.1 |

V. Strawberry Flavored 1% Milk—All following examples are made using conventional techniques and are tested in a dairy case set up (refrigerated) for six days (all examples test better than control).

Control

| Ingredient | % |
|---|---|
| 1% Strawberry Milk | 100 |

### Example 44

| Ingredient | % |
|---|---|
| 1% Strawberry Milk | 99.828 |
| Magnesium Phosphate Tribasic Pentahydrate | 0.1648 |
| Manganese Ascorbate | 0.002452 |
| Zinc Oxide | 0.0024 |
| Ferrous Gluconate | 0.002012 |

### Example 45

| Ingredient | % |
|---|---|
| 1% Strawberry Milk | 99.826 |
| Magnesium Phosphate Tribasic Pentahydrate | 0.1648 |
| Manganese Ascorbate | 0.002452 |
| Zinc Oxide | 0.0048 |
| Ferrous Gluconate | 0.002012 |

### Example 46

| Ingredient | % |
|---|---|
| 1% Strawberry Milk | 99.611 |
| Magnesium Gluconate | 0.288 |
| Manganese Citrate | 0.001314 |
| Inositol | 0.1 |

### Example 47

| Ingredient | % |
|---|---|
| 1% Strawberry Milk | 99.816 |
| Magnesium Phosphate Tribasic Pentahydrate | 0.1648 |
| Manganese Ascorbate | 0.002452 |
| Zinc Gluconate | 0.0138 |
| Ferrous Gluconate | 0.002012 |

### Example 48

| Ingredient | % |
|---|---|
| 1% Strawberry Milk | 99.803 |
| Magnesium Phosphate Tribasic Pentahydrate | 0.1648 |
| Manganese Ascorbate | 0.002452 |
| Zinc Gluconate | 0.0276 |
| Ferrous Gluconate | 0.002012 |

### Example 49

| Ingredient | % |
|---|---|
| 1% Strawberry Milk | 99.831 |
| Magnesium Phosphate Tribasic Pentahydrate | 0.1648 |
| Manganese Ascorbate | 0.002452 |
| Ferrous Gluconate | 0.002012 |

### Example 50

| Ingredient | % |
|---|---|
| 1% Strawberry Milk | 99.611 |
| Ascorbic Acid | 0.02 |
| Magnesium Ascorbate | 0.268 |
| Manganese Citrate | 0.001314 |
| Mannitol | 0.1 |

VI. Plain Fat Free Yogurt—All following examples are made using conventional techniques and are tested in a dairy case set up (refrigerated) for six days (all examples test better than control). 7% sugar (by weight of the yogurt component) is added to make tasting easier. The product is topped off with the ingredients and not reprocessed.

Control

| Ingredient | % |
|---|---|
| Plain Fat Free Yogurt (7% added sugar) | 100 |

### Example 51

| Ingredient | % |
|---|---|
| Plain Fat Free Yogurt (7% added sugar) | 98.493 |
| Zinc Gluconate | 0.0276 |
| Magnesium Phosphate Tribasic Pentahydrate | 0.1648 |
| Inositol | 1.0 |
| Calcium Citrate | 0.313 |
| Manganese Citrate | 0.001314 |

### Example 52

| Ingredient | % |
|---|---|
| Plain Fat Free Yogurt (7% added sugar) | 99.66 |
| Zinc Oxide | 0.0048 |
| Magnesium Oxide | 0.021 |
| Calcium Citrate | 0.313 |
| Manganese Citrate | 0.001314 |

### Example 53

| Ingredient | % |
|---|---|
| Plain Fat Free Yogurt (7% added sugar) | 98.608 |
| Zinc Gluconate | 0.0276 |
| Magnesium Carbonate | 0.0504 |
| Inositol | 1.0 |
| Calcium Citrate | 0.313 |
| Manganese Citrate | 0.001314 |

### Example 54

| Ingredient | % |
|---|---|
| Plain Fat Free Yogurt (7% added sugar) | 98.665 |
| Magnesium Oxide | 0.021 |
| Inositol | 1.0 |
| Calcium Citrate | 0.313 |
| Manganese Citrate | 0.001314 |

### Example 55

| Ingredient | % |
|---|---|
| Plain Fat Free Yogurt (7% added sugar) | 99.637 |
| Zinc Gluconate | 0.0276 |
| Magnesium Oxide | 0.021 |
| Calcium Citrate | 0.313 |
| Manganese Citrate | 0.001314 |

### Example 56

| Ingredient | % |
|---|---|
| Plain Fat Free Yogurt (7% added sugar) | 98.83 |
| Magnesium Phosphate Tribasic Pentahydrate | 0.1648 |
| Manganese Gluconate | 0.00294 |
| Inositol | 1.0 |
| Ferrous Gluconate | 0.002012 |

### Example 57

| Ingredient | % |
|---|---|
| Plain Fat Free Yogurt (7% added sugar) | 98.637 |
| Zinc Gluconate | 0.0276 |
| Magnesium Oxide | 0.021 |
| Inositol | 1.0 |
| Calcium Citrate | 0.313 |
| Manganese Citrate | 0.001314 |

VII. Strawberry Kiwi 99% Fat Free Yogurt—All following examples are made using conventional techniques and are tested in a dairy case set up (refrigerated) for six days (all examples test better than control). The product is topped off with the ingredients and not reprocessed.

Control

| Ingredient | % |
|---|---|
| Strawberry Kiwi 99% Fat Free Yogurt | 100 |

### Example 58

| Ingredient | % |
|---|---|
| Strawberry Kiwi 99% Fat Free Yogurt | 98.665 |
| Magnesium Oxide | 0.021 |
| Inositol | 1.0 |
| Calcium Citrate | 0.313 |
| Manganese Citrate | 0.001314 |

### Example 59

| Ingredient | % |
|---|---|
| Strawberry Kiwi 99% Fat Free Yogurt | 98.66 |
| Zinc Oxide | 0.0048 |
| Magnesium Oxide | 0.021 |
| Calcium Citrate | 0.313 |
| Manganese Citrate | 0.001314 |

What is claimed is:

1-47. (canceled)

48. Method for stabilizing the flavor of a dairy-derived food product comprising from about 0.01% to about 20% dairy protein against deterioration by sunlight or fluorescence, comprising adding to said food product a stabilizing effective amount of a stabilizing mixture comprising
(i) from about 0.000001% to about 0.2% of a metal, in the form of ions, salts, oxides, complexes, chelates or nonionic forms, selected from zinc, magnesium, calcium, chromium, copper, iron, selenium, manganese, and combinations thereof; and
(ii) from about 0.01% to about 2.5% of an adjunct component selected from ascorbic acid, erhthorbic acid, sugar alcohols, ascorbates, erythorbates, and combinations thereof.

49. The method according to claim 48 wherein the food product is in the form of a beverage.

50. The method according to claim 49 wherein the beverage is selected from milk, flavored milk, milk-based beverages, milk/juice blends, yogurt-based drinks, cultured or noncultured dairy-based drinks, acidified milk beverages, and soft drinks.

51. The method according to claim 49 wherein the adjunct component comprises ascorbic acid, an ascorbate, or combinations thereof.

52. The method according to claim 49 wherein the metal comprises zinc, magnesium, manganese, iron, and combinations thereof.

53. The method according to claim 51 wherein the metal is selected from zinc, magnesium, manganese, iron, and combinations thereof.

54. The method according to claim 51 wherein the food product additionally contains an effective amount of a flavor-masking component.

55. The method according to claim 49 wherein the adjunct component comprises a sugar alcohol selected from mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof.

56. The method according to claim 52 wherein the adjunct component comprises a sugar alcohol selected from mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof.

57. The method according to claim 48 wherein the metal is selected from zinc, magnesium, calcium, copper, iron, manganese, and combinations thereof.

58. The method according to claim 49 which the metal is selected from: from about 0.0013% to about 0.34% magnesium, from about 0.000013% to about 0.0034% manganese, from about 0.000025% to about 0.0031% iron (ferrous or ferric), from about 0.0000048% to about 0.00048% copper, from about 0.0065% to about 65% calcium, from about 0.00037% to about 0.037% zinc, and combinations thereof; and the adjunct component is selected from 0.01% to about 1% sugar alcohol, from about 0.01% to about 0.2% ascorbic acid, and combinations thereof.

59. The method according to claim 58 wherein the metal is magnesium which is added to the food product in the form of a material selected from magnesium oxide, magnesium carbonate, magnesium citrate, magnesium gluconate, magnesium ascorbate, magnesium malate, magnesium lactate, magnesium succinate, magnesium hydroxide, magnesium chloride, magnesium stearate, magnesium sulfate, magnesium phosphate, and combinations thereof.

60. The method according to claim 59 wherein the magnesium is added to the food product in the form of a material selected from magnesium oxide, magnesium carbonate, magnesium ascorbate, magnesium malate, magnesium phosphate, and combinations thereof.

61. The method according to claim 58 wherein the metal is manganese which is added to the food product in the form of a material selected from manganese gluconate, manganese ascorbate, manganese lactate, manganese sulfate, manganese carbonate, manganese oxide, manganese chloride, manganese citrate, and combinations thereof.

62. The method according to claim 61 wherein the manganese is added to the food product in the form of a material selected from manganese gluconate, manganese sulfate, manganese citrate, and combinations thereof.

63. The method according to claim 58 wherein the adjunct material is sugar alcohol which is added to the food product in the form of a material selected from mannitol, inositol, erythritol, xylitol, sorbitol, lactitol, maltitol, isomalt, hydrogenated starch hydrolosates, inulin, galctitol, ribitol, dithioerythritol, dithiothreitol, glycerol, and combinations thereof.

64. The method according to claim 63 wherein the sugar alcohol is added to the food product in the form of a material selected from inositol, xylitol, mannitol, erythritol, and combinations thereof.

65. The method according to claim 58 wherein the metal is iron which is added to the food product in the form of a material selected from ferric ammonium citrate, ferric chloride, ferric phosphate, ferric sulfate, ferrous ascorbate, ferrous carbonate, ferrous sulfate, ferrous gluconate, ferrous lactate, ferrous fumarate, and combinations thereof.

66. The method according to claim 65 wherein the iron is added to the food product in the form of a material selected from ferric ammonium citrate, ferrous gluconate, ferrous lactate, and combinations thereof.

67. The method according to claim 58 wherein the metal is copper which is added to the product in the form of a material selected from copper citrate, copper acetate, copper sulfate, copper gluconate, and combinations thereof.

68. The method according to claim 67 wherein the copper is added to the food product in the form of copper gluconate.

69. The method according to claim 58 wherein the metal is calcium which is added to the food product in the form of a material selected from calcium lactate, calcium citrate, calcium sulfate, calcium hydroxide, calcium carbonate, calcium acetate, calcium gluconate, calcium oxide, calcium propionate, calcium stearate, calcium chloride, and combinations thereof.

70. The method according to claim 69 wherein the calcium is added to the food product in the form of a material selected from calcium lactate, calcium citrate, and combinations thereof.

71. The method according to claim 58 wherein the metal is zinc which is added to the product in the form of a material selected from zinc oxide, zinc lactate, zinc citrate, zinc picolinate, zinc sulfate, zinc chloride, zinc stearate, zinc gluconate, and combinations thereof.

72. The method according to claim 71 wherein the zinc is added to the food product in the form of a material selected from zinc oxide, zinc gluconate, and combinations thereof.

73. The method according to claim 48 wherein food product is in the form of a yogurt-based product.

74. The method according to claim 73 wherein the adjunct component comprises a material selected from ascorbic acid, an ascorbate, or combinations thereof.

75. The method according to claim 73 wherein the metal comprises a material selected from magnesium, zinc, manganese, iron, and combinations thereof.

76. The method according to claim 73 wherein the food product additionally contains an effective amount of a flavor-masking component.

77. The method according to claim 73 wherein the adjunct component comprises a sugar alcohol selected from mannitol, inositol, erythritol, xylitol, sorbitol, lactitol, maltitol, isomalt, hydrogenated starch hydrolysates, inulin, galactitol, ribitol, dithioerythritol, dithiothreitol, glycerol, and combinations thereof.

78. The method according to claim 73 wherein the metal is selected from: from about 0.0013% to about 0.34% magnesium, from about 0.00003% to about 0.003% manganese, from about 0.0000025% to about 0.00025% iron (ferrous or ferric), from about 0.0065% to about 0.65% calcium, from about 0.00039% to about 0.039% zinc, and combinations thereof; and an adjunct component selected from 0.1% to about 10% sugar alcohol, from about 0.001% to about 0.2% ascorbic acid, and combinations thereof.

79. The method according to claim 78 wherein the metal is magnesium and is added to the product in the form of a material selected from magnesium oxide, magnesium carbonate, magnesium phosphate, and combinations thereof.

80. The method according to claim 78 wherein the metal is manganese and is added to the product in the form of a material selected from manganese gluconate, manganese citrate, and combinations thereof.

81. The method according to claim 78 wherein the adjunct component is sugar alcohol and is added to the product in the form of inositol.

82. The method according to claim 78 wherein the metal is iron and is added to the product in the form of ferrous gluconate.

83. The method according to claim 78 wherein the metal is calcium and is added to the product in the form of calcium citrate.

84. The method according to claim 78 wherein the metal is zinc and is added to the product in the form of a material selected from zinc oxide, zinc gluconate, and combinations thereof.

85. The method according to claim 48 wherein the food product is in the form of salad dressing.

86. The method according to claim 48 wherein the food product is substantially free of yogurt.

87. The method according to claim 48 wherein the stabilizing mixture comprises from about 0.000001% to about 0.1% of the metal, and from about 0.01% to about 1.5% of the adjunct component.

88. The method according to claim 50 wherein the beverage is noncultured and the metal is selected from zinc, magnesium, calcium, copper, manganese, and combinations thereof.

89. The method according to claim 88 wherein the metal comprises zinc, magnesium, manganese, and combinations thereof.

90. The method according to claim 88 wherein the beverage comprises from about 0.000001% to about 0.1% of the metal.

91. The method according to claim 49 wherein the beverage is cultured and the metal is selected from zinc, magnesium, calcium, copper, iron, manganese, and mixtures thereof.

92. The method according to claim 91 wherein the metal comprises zinc, magnesium, manganese, and mixtures thereof.

93. The method according to claim 91 wherein the beverage comprises from about 0.000001% to about 0.1% of the metal.

94. The method according to claim 48 wherein the food product is in the form of sour cream or dip.
